(19) United States
(12) Patent Application Publication
(10) Pub. No.: US 2002/0032575 A1
(43) Pub. Date: Mar. 14, 2002

(54) System and method for responding to an inquiry in exchange for a resource over a communication network

(76) Inventor: Ken Lang, Wellesley, MA (US)

Correspondence Address: LAHIVE & COCKFIELD, 28 STATE STREET, BOSTON, MA, 02109, US

(21) Appl. No.: 09/854,199

(22) Filed: May 11, 2001

Related U.S. Application Data
(60) Provisional application No. 60/214,149, filed on Jun. 26, 2000.

(51) Int. Cl. G06F 17/60

(52) U.S. Cl. 705/1

(57) ABSTRACT

In vehicles provided for an inquiring party to submit an inquiry via a communication system to an appropriate responding party that attends to the inquiry in response for receiving emuneration, such as a monetary reward. For example, a first party may use the vehicle to submit an email inquiry that is matched to the appropriate responding party that then generates a response and receives a monetary credit for generating a response. One example is a prominent businessman who agrees to respond to business proposals via email in exchange for payment. Software may be provided in the system to facilitate the advertisement of individuals who will respond to inquiries and the cost for such inquiries.

### RELATED APPLICATIONS

This application claims the benefit of priority under 35 U.S.C. 119(e) to co-pending U.S. provisional application Serial No. 60/214,149, filed Jun. 26, 2000, the entire contents of which are hereby incorporated by reference.

### TECHNICAL FIELD

The present invention relates generally to business methods and more particularly to a business method for responding to an inquiry hosted on a communications network in exchange for a resource, such as remuneration.

### BACKGROUND OF THE INVENTION

The advent of the information super highway or Internet has rapidly increased awareness and acceptance of the Internet as a resource for acquiring content or for exchanging information or resources. Hence, the Internet is rapidly replacing more traditional methods for obtaining and exchanging information, such as books, journals, newspapers, magazines and even television, and for facilitating exchanges of resources between people or companies. The Internet is typically accessed by the use of a web browser, which provides a graphical user interface on a client machine. The web browser is configured for communicating with one or more web servers.

Today, certain people may require access to individuals who can provide a response or recommendation to an inquiry or question that person may have. It is generally difficult for a person to locate an individual who can provide an appropriate response to the inquiry in a timely, efficient manner in exchange for a pre-established resource. Further, people who have high levels of expertise or are frequently contacted to provide information or responses to inquiries, generally find their time restricted because of the sheer volume of inquiries.

One difficulty that has arisen with regard to highly sought after people, is that their available time and general ability to respond to the inquiries posted by individuals is highly restricted. It would therefore be advantageous to provide a that allows an inquirer to provide an inquiry, and to access an appropriately qualified individual or consultant to respond to the inquiry.

### SUMMARY OF THE INVENTION

The above-described limitations and disadvantages are overcome by the present system that provides for a system and method for matching an inquirer having an inquiry with a suitable consultant that is capable of responding to the inquiry for a predetermined resource or amount. According to one practice, the system is a communication network, such as the Internet, which matches inquirers with consultants in order to provide a the response to an inquiry for a predetermined resource. The resource can be exchanged between the consultant and the inquirer over the network, or through some other known medium, such as mail, telephone, wireless networks, and other such exchange medium.

The inquirer can specify a particular profile of the consultant that the inquirer desires to respond to the inquiry or, conversely, the consultant can specify the profile of the inquirer whose inquiry the consultant intends to respond. The system and method of the present invention further contemplates providing an identity verification facility that enables the system provider to verify the profile of the consultant or the inquirer.

Other general and more specific objects of the invention will in part be obvious and will in part be evident from the drawings and description which follow.

### BRIEF DESCRIPTION OF THE DRAWINGS

The foregoing and other objects, features and advantages of the invention will be apparent from the following description and apparent from the accompanying drawings, in which like reference characters refer to the same parts throughout the different views. The drawings illustrate principles of the invention and, although not to scale, show relative dimensions.

FIG. 1 is a schematic block diagram of a communication network configured for allowing an inquirer to access and seek the response from a consultant in accordance with the teachings of the present invention.

FIG. 2 is a schematic flow chart diagram illustrating the system of the invention which is configured for hosting and responding to an inquiry in exchange for a resource.

FIG. 3 is a schematic flow chart diagram illustrating the method for verifying the profile of an inquirer or consultant in accordance with the teachings of the present invention.

FIG. 4 is a schematic flow chart diagram illustrating the method for ensuring the consultant attends to an inquirer provided by an inquirer in accordance with the teachings of the present invention.

FIG. 5 is a schematic flow chart diagram illustrating the method for having the communication network or provider verify the identity or profile of the inquirer or consultant in accordance with the teachings of the present invention.

### DESCRIPTION OF ILLUSTRATED EMBODIMENT

An integrated Internet enabled system for providing an inquiry, allowing a consultant to respond to the inquiry, and then facilitating the exchange of a predetermined resource between an inquirer and the consultant.

For purposes of the discussion below it is helpful to clarify the meaning of a few terms.

The term “consultant” is intended to include an individual, company, partnership, sole proprietorship, joint venture, non-profit organization, consortium, or other similar or like entity, that is capable, desirous or responsible for responding to an inquiry.

The term “inquirer” is intended to include an individual, company, partnership, sole proprietorship, joint venture, non-profit organization, consortium, or other similar or like entity, that is desirous of having an inquiry responded to or answered by the consultant.

The term “inquiry” is intended to include a question, solicitation, or request for information or data created or proffered by the inquirer or on behalf of the inquirer.

The term “resource” is intended to include a promise of payment or payment, such as money or other suitable legal tender, or other instruments that can be valued or tied in valuation to a legal currency or other goods or services, such as the dollar, yen, euro or the like. The term can also includes services, including personnel or other types of services, promises of services or goods, exchanged goods or services, or donated goods or services, which the inquirer/consultant are willing to exchange in return for responding to the inquiry. The resource also contemplates the exchange of no goods or services.

The term “provider” is intended to include any third party operating a communication network or automated network that establishes the environment for the inquirer to seek the services of the consultant, or for the consultant and the inquirer to exchange resources.

The term “profile” is intended to include any relevant data or information concerning, relating or associated with the consultant and/or inquirer.

The term “communication network” is intended to include any client-server or computer network, such as the Internet, intranet, extranet, WAN, LAN, or other varieties of computer networks or the like, telephone network, such as a public switched telephone network (PSTN) or a private telephone network, wireless telephone network, hybrid systems, and other such means including electronic appliances for exchanging information, data, and resources between any of the provider, consultant and inquirer.

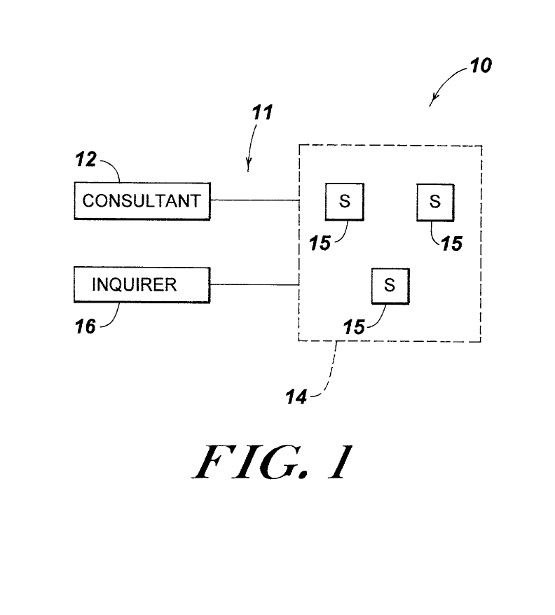

FIG. 1 illustrates a communication system 10 that includes a communication network 11 having a first client machine 12 coupled to a network 14 by any suitable connection. The illustrated client machine 12 can be any suitable personal computer or similar computing apparatus that can be coupled in a network configuration with the network 14. The client machine 12 can also form part of an additional network, which in turn communicates with the network 14. Hence, the client machine 12 can contain various forms of hardware and software according to known distributed processing techniques. The client machine can also be an electronic appliance, such as a pager, cell phone, personal data assistant, and the like. The illustrated network 14 can employ one or more servers, schematically illustrated as servers 15. The servers can be arranged in any conventional manner which would be obvious to those of ordinary skill in the art. The network 14 can be coupled with the client machine 12 to form the overall communication network 11, and is preferably configured in a specialty client-server relationship called the Internet. For purposes of clarity, we refer below to the network 14 as the web 14, and the servers 15 as the web servers. Those of ordinary skill will readily recognize that the teachings of the invention also apply to all forms of intranets, extranets, IP networks, and the like.

The illustrated client machine 12 can communicate with the web 14 utilizing known functionality's, such as the functionality provided by the hypertext transfer protocol (HTTP). The web 14 includes web servers 15 that support the TCP/IP protocol suite, and which are addressable to client machines via universal resource locators (URLs). In a conventional web connection, the illustrated client machine 12 employs a browser, such as a web browser, which establishes the connection with the web 14 to present information to a user via a user interface. The web servers 15 in the web 14 execute corresponding server software which presents information to the client machine 12 in the form of HTTP responses or packets. The HTTP responses correspond to web pages constructed from a Hypertext Markup Language (HTML), or other server-generated data. A consultant can access, retrieve or provide information, such as a response, to the communication network 11 through the client machine 12, and hence will be referred to hereinafter as the consultant for purposes of clarity.

The illustrated communication system 10 further includes a second client machine 16 that communicates with the web 14 through any suitable connection. The second client machine 16 can be configured identical to the consultant 12. An inquirer can access the network 11, provide an inquiry, and retrieve a response from the consultant through the client machine 16. For purposes of clarity, the second client machine 16 will be referred to hereinafter as the inquirer in order to differentiate the use of the second client machine from the consultant 12.

The illustrated communication system 10 is designed to allow an inquirer 16 to provide an inquiry to the system, as well as a resource associated with the inquiry, for subsequent response by the consultant 12. For example, the inquirer 16 can input to the web 14 an inquiry through any suitable input device, such as a keyboard, stylus, and the like. The inquiry can be responded to by a consultant 12 in exchange for the established resource. The resource can be exchanged over the communication network 11, or through any other suitable means, such as through standard delivery media, such as by mail, or through the use of other types of exchange resources, such as escrow accounts, agents and the like. Those of ordinary skill will readily recognize the various types of techniques that can be employed to exchange the resource between the consultant, inquirer, and if desired the provider. The illustrated communication system 10 further allows the consultant 12 to establish the resource for responding to an inquiry posted by the inquirer 16. Hence, the inquirer 16 can provide an inquiry to the system 10 for response by a consultant in exchange for the resource established by the consultant.

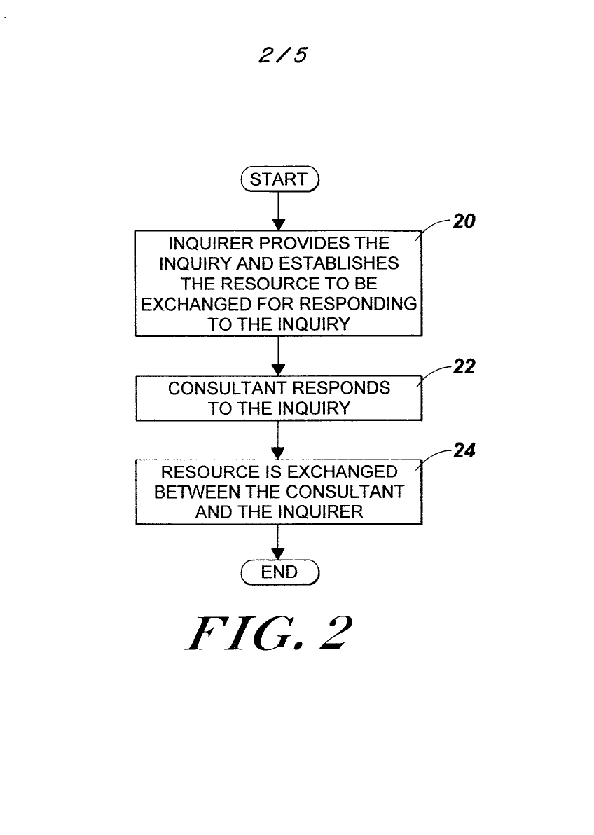

For example, with reference to FIG. 2, the system 10 of the present invention allows the inquirer 12 to input through an inquiry facility an inquiry to the web 14. The inquirer 16 also establishes the resource the inquirer is willing to pay in exchange for receiving an appropriate response by the consultant 12 to the inquiry. This is illustrated in step 20. The system 10 further allows the consultant 12 to respond to the inquiry through an input device and a consultant facility by providing a response to the network 11, step 22. The inquirer 16 can access and retrieve the response from the network 11. Alternatively, once a suitable response is received to the inquiry, the web 14 can convey or transfer the response to the inquirer 16 through any appropriate communication link. Once the response is received by the inquirer 16, the predetermined or established resource can be exchanged between the consultant and the inquirer through an exchange facility. According to one practice, the system 10 enables the provider to exchange the resource between the inquirer 16 and the consultant 12 by functioning as an escrow account or intermediate third party exchange facility. Conversely, once the response is received and deemed appropriate by the inquirer 16, the resource can be exchanged directly between the consultant and the inquirer through any conventional transfer technique, or can be exchanged between the inquirer and the consultant through a third party, such as an agent other than the provider.

The inquiry provided by the inquirer or the response provided by the consultant can take many forms. For example, the inquiry or the response can be an electronic communication, such as email, containing the inquiry or response. Alternatively, a hard copy of the inquiry or the response can be sent via conventional mail or courier service. Still further, the response can take the form of an electronic communication other than an email message. The network 11 can employ a programmatic entity (such as a computer program) that is capable of taking the electronic communication constituting the response and extracting information therefrom. For security purposes, the response can be encrypted or can include encrypted information. Digital signatures and other information may be affixed to the response to prevent fraudulent communication of information over the communication network 11.

If the information or inquiry provided by the inquirer and/or response provided by the consultant is of a proprietary nature, the system 10 can employ any selected available security technique, such as encryption, passwords, and the like to protect the proprietary nature of the information exchanged over the communication network 11.

As set forth above, the consultant 12 can also establish or determine the resource that the consultant is willing to receive in exchange for responding to an inquiry provided by the inquirer 16.

The communication system 10 of the present invention further enables the consultant 12 or inquirer 16 to provide a profile for review by the other. The profile enables the provider to provide information regarding the qualifications or other information associated or related to the consultant or inquirer. This information enables either the consultant or inquirer to determine the quality of the response rendered by the consultant to an inquiry, or the type of inquiry which the consultant desires to handle. The profile can further be employed by the provider as an information tool that can be disseminated to either the consultant 12 or inquirer 16 when requested. According to this practice, the information would not normally be disseminated in the normal course of utilizing the system 10, but rather is disseminated upon a specific request by either the consultant or the inquirer.

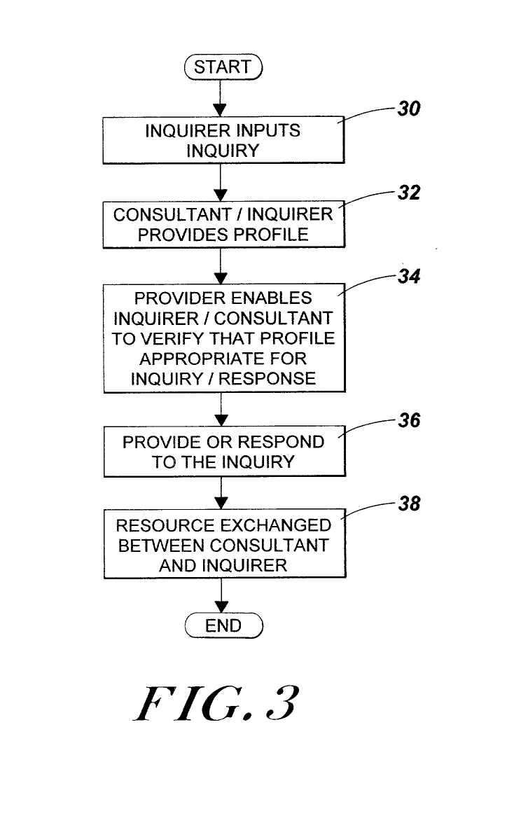

FIG. 3 is a schematic flow chart diagram of the logical steps initiated by the system 10 of the present invention. In operation, the inquirer 16 inputs an inquiry to the system 10 in any known conventional manner, step 30. The system 10 allows the consultant 12 or inquirer 16 to provide a profile corresponding thereto to the system, step 32. The profile can be unique to the consultant or inquirer, or can pertain to a class of consultants or inquirers utilizing the system. The profile is intended to allow an inquirer to verify or ascertain the qualifications of a consultant 12 responding to the inquiry. Conversely, the inquirer 16 can submit a profile for review by the consultant to enable the consultant to determine whether to respond to the inquiry, or to select particular inquiries for response.

The provider also enables the inquirer or consultant to verify that the profile of either party is appropriate for either submitting an inquiry or providing a response, step 34. The consultant can then provide or respond to the inquiry posted by the inquirer, step 36, and the resource established by the consultant or inquirer can then be exchanged therebetween, step 38.

An advantage of this feature is that it allows the system to provide information to the inquirer regarding the qualifications of the consultants. This ensures the inquirer that the inquiry is being handled by a qualified consultant. Another advantage is that the consultant can select one or more inquiries from a class of inquiries that the consultant desires to handle. The system 10 thus functions as a filter or reservoir for collating a set of inquiries, one or more of which the consultant can decide to respond.

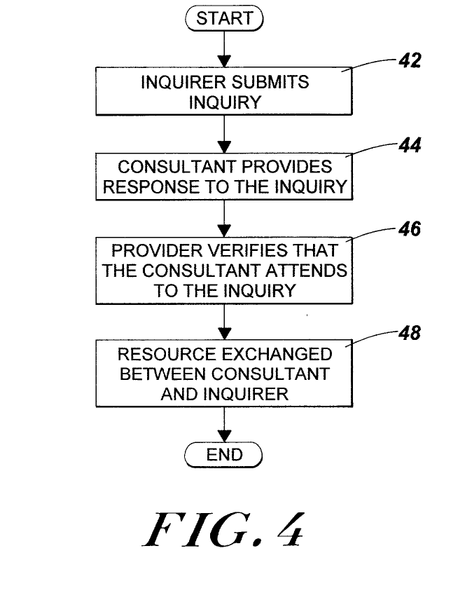

FIG. 4 is a schematic flow chart diagram of a method implemented by the system 10 for verifying that the consultant sufficiently considered and attended to the inquiry provided by the inquirer. According to one practice of the invention, the inquirer 16 submits an inquiry to the system, step 42, and the consultant 12 considers the inquiry and provides an appropriate response, step 44. The provider verifies that the consultant 12 appropriately and properly attended to the inquiry by verifying with the consultant that the inquiry was received, properly considered, and that a sufficient response is rendered by the consultant 12, step 46. There are a number of different methods and techniques that the provider can employ to ensure that the consultant sufficiently and accurately considers the inquiry provided by the inquirer 16. Particular techniques that can be employed include questionnaires submitted by the consultant declaring or verifying that the inquiry was sufficiently considered prior to rendering a response. Other techniques include monitoring or tracking the amount of time spent by the consultant when considering the inquiry and developing an appropriate response. Those of ordinary skill will readily recognize that other monitoring, tracking or verification techniques can be employed and are contemplated by the scope of the present invention. The system 10 then enables the resource to be exchanged between the consultant and the inquirer, step 48.

A significant advantage of verifying that the consultant 12 properly attends to or considers the inquiry is that it ensures high quality responses to the posted inquiry. Another advantage is that it ensures that the inquirer is receiving information commensurate with the resource provided by the inquirer. Those of ordinary skill will readily recognize that the system 10 can be configured to optimize or modify the amount of time required to be spent by the consultant as a function of the type and amount of the resource.

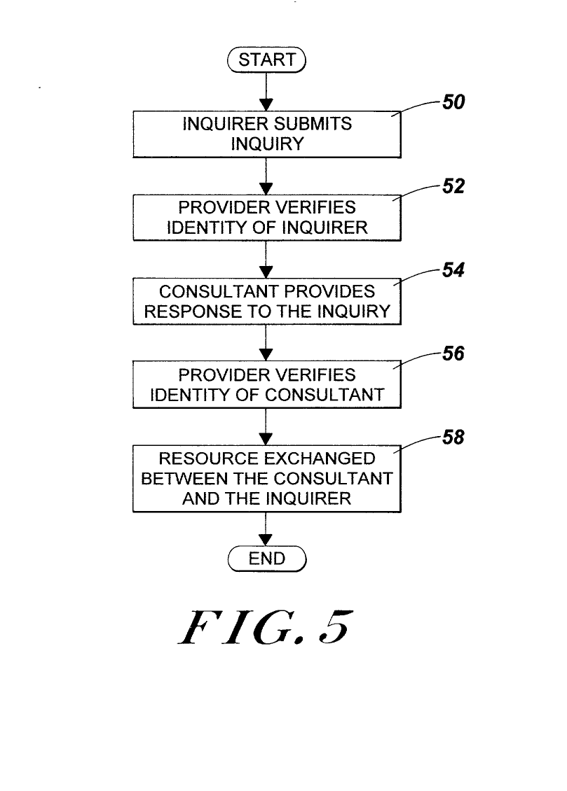

The illustrated system 10 of the present invention further verifies the identity of the inquirer and/or consultant utilizing the system. This enables the provider to verify the integrity of the inquiries submitted to the system as well as the responses provided by the consultants to the system. With reference to FIG. 5, the inquirer 16 submits an inquiry to the system, step 50, and the provider verifies the identity of the inquirer submitting the inquiry, step 52. The provider can verify the identify of the inquirer according to many known conventional techniques, such as requiring the inquirer to submit a password or other type of code. Those of ordinary skill will readily recognize that other verification techniques can be employed by the system 10 of the present invention. The consultant 12 can provide a response to the inquiry to the system, step 54, and the provider can also verify, if desirable, the identify of the consultant utilizing the system, step 56. The provider can identify the consultant in much the same way that the provider verified the identity of the inquirer. Once the consultant provides a response to the posted inquiry, the resource established by the consultant or inquirer can be exchanged therebetween, step 58.

One difficulty that may arise with respect to use and function of the system 10 is the lack of ability to determine the reputation or reliability of the parties that employ the system 10. The system 10 can therefore further employ a reputation/trust information facility for use by either the inquirer or the consultant. According to one practice, the system 10 can employ a reputation service or facility (stored on the web 14 on one or more servers 15) that may be generalized to hold information regarding the reputation of a party as to multiple traits or characteristics. The information stored or retained by the system can be updated so as to provide current, updated verification information of either or both the inquirer and the consultant. Safeguards can be provided for ensuring that the information upon which a reputation is based is valid and reliable. Access to certain reputation information via the reputation service or facility may be restricted so that only authorized persons can access the reputation information, based upon certain selected occurrences, such as completion of a transaction (e.g., such as providing a response to a posted inquiry), as well as according to other known characteristics. Those of ordinary skill will readily recognize that a reputation or trust service in accordance with known techniques can be employed by the present invention. For example, verification or trust information can be provided in much the same way as employed by auction-type websites present available on the Internet. Another reputation or trust service that is suitable for use by the system 10 of the present invention is shown and described in Attorney Docket No. KLQ-004, the contents of which are herein incorporated by reference.

The system 10 of the present invention can also automatically match a consultant with an inquirer based upon the pre-established profiles of both the consultant and the inquirer. The matching facility of the system can match the consultant to the inquiry based on one or more traits or characteristics contained within the profile submitted by the consultant and inquirer, according to known techniques. Moreover, the matching facility can optimize the matching of a consultant with an inquirer based upon whether a consultant matches the profile posted by the inquirer. Conversely, the matching facility can optimize the matching of an inquirer with a consultant based upon the profile established by one or more consultants which may otherwise meet pre-selected or pre-determined criteria.

A significant advantage of the present invention is that it enables an inquirer to solicit and receive a response to an inquiry posted over a communication network in a relatively easy, fast and efficient manner in exchange for a resource, such as money, pre-determined by the consultant or inquirer. Another significant advantage of the present invention is that the resources exchanged between the consultant and the inquirer can occur in a relatively safe and risk-free environment. For example, verifying the identities of the consultant and inquirer during the transaction ensures a properly handled transaction between the consultant and inquirer. Furthermore, the provider can either directly provide for the exchange between the inquirer and the consultant, or can allow the resource to be exchanged between the parties according to criteria determined between the parties.

Another significant advantage of the present invention is that it enables the consultant to filter inquiries that they may otherwise receive by requiring payment of a resource as established by the consultant. On the other hand, the system also allows the inquirer to select a qualified consultant from a set of consultants from which they desire to receive a response for an amount pre-determined by the inquirer.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

Having described the invention, what is claimed as new and desired to be secured by Letters Patent is:

1. A method for responding to an inquiry by an inquirer in exchange for an established resource over a communication network, said method comprising the steps of
providing an inquiry by an inquirer that requires a response over the communication network,
providing a response to the inquiry by a consultant over the communication network, and
exchanging the resource between the consultant and the inquirer for responding to the inquiry.

2. The method of claim 1, wherein the communications network comprises the internet.

3. The method of claim 1, further comprising the step of establishing the resource exchanged between the consultant and the inquirer.

4. The method of claim 3, wherein the step of establishing the resource comprises the step of establishing the resource by one of the consultant, the inquirer, and the provider.

5. The method of claim 3, wherein the step of establishing the resource comprises the step of negotiating the resource between the inquirer and the consultant.

6. The method of claim 1, further comprising the step of establishing a profile of the consultant or the inquirer.

7. The method of claim 6, further comprising the step of verifying the profile of the consultant.

8. The method of claim 1, further comprising the steps of establishing a profile of the consultant or the inquirer, and verifying the profile of the consultant or the inquirer.

9. The method of claim 1, further comprising the step of matching a consultant with an inquirer based upon a pre-established profile of at least one of the consultant and the inquirer.

10. The method of claim 1, further comprising the steps of establishing a profile of the consultant, and matching the inquirer with the consultant based on the profile.

11. The method of claim 1, further comprising the steps of
establishing a profile of the consultant,
establishing a profile of the inquirer, and
matching the inquirer with the consultant based on the established profiles.

12. In a communications network having a client machine and a server, a method for responding to an inquiry by an inquirer in exchange for a resource, said method comprising the steps of
providing an inquirer with access to the communications network to furnish an inquiry that requires a response,
providing a consultant with access to the communication network for responding to the inquiry of the inquirer, and
exchanging a resource between the consultant and the inquirer for responding to the inquiry.

13. A system for responding to an inquiry by an inquirer in exchange for an established resource, comprising
an inquiry facility for providing an inquirer having an inquiry that requires a response,
a consultant facility for providing a consultant for responding to the inquiry of the inquirer, and
an exchange facility for exchanging a resource between the consultant and the inquirer for responding to the inquiry.

14. The system of claim 13, further comprising a communications network for allowing the consultant to respond to the inquiry.

15. The system of claim 14, wherein the communications network comprises the internet.

16. The system of claim 13, further comprising means for establishing a profile of the consultant or the inquirer.

17. The system of claim 16, further comprising means for verifying the profile of the consultant.

18. The system of claim 13, further comprising means for allowing the inquirer to specify the profile of the consultant.

19. The system of claim 13, further comprising a matching facility for matching a consultant with an inquirer based upon a pre-established profile of at least one of the consultant and the inquirer.

20. The system of claim 19, wherein said matching facility comprises
means for establishing a profile of at least one of the consultant and the inquirer, and
means for matching the inquirer with the consultant based on the profile.

21. In a communications network, a business method for responding to an inquiry by an inquirer in exchange for a resource in order to facilitate response to the inquiry, said method comprising the steps of
accepting an inquiry from an inquirer that requires a response,
allowing a consultant to respond to the inquiry of the inquirer, and
providing for an exchange of the resource between the consultant and the inquirer for responding to the inquiry.

22. The method of claim 21, further comprising the step of establishing the resource exchanged between the consultant and the inquirer.

23. The method of claim 22, wherein the step of establishing the resource comprises the step of establishing the resource by at least one of the consultant, the inquirer, and the provider.

24. The method of claim 21, further comprising the step of establishing a profile of at least one of the consultant and the inquirer.

25. The method of claim 21, further comprising the step of verifying the profile of the consultant.

26. The method of claim 21, further comprising the step of allowing the inquirer to specify the profile of the consultant.

27. The method of claim 21, further comprising the step of matching a consultant with an inquirer based upon a pre-established profile of at least one of the consultant and the inquirer.

28. The method of claim 21, further comprising the steps of
establishing a profile of at least one of the consultant and the inquirer, and
matching the inquirer with the consultant based on the profile.
